(19) United States
(12) Patent Application Publication
(10) Pub. No.: US 2007/0244927 A1
(43) Pub. Date: Oct. 18, 2007

(54) Circular Matching System and Computerized Circular Matching Method

(75) Inventors: Dong-hyun Lee, Seoul (KR); Ja-kyung Lee, Gueonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: MEDINTEL CO LTD., Seoul (KR)

(21) Appl. No.: 11/587,497

(22) PCT Filed: Apr. 22, 2005
(86) PCT No.: PCT/KR05/01161

§ 371 Date: Oct. 26, 2006

(30) Foreign Application Priority Data
Apr. 29, 2004 (KR) 10-2004-0030042

(51) Int. Cl. G06F 17/30

(52) U.S. Cl. 707/104.1

(57) ABSTRACT

Disclosed herein are a circular matching system and a circular matching process, which provide a circle in which a plurality of preexisting pairs, in each of which the members are unsatisfied with each other according to predetermined criteria, are swapped in a circular manner to form new optimal or suitable pairs whose members are satisfied with the new partners on the basis of the predetermined standards.

### TECHNICAL FIELD

The present invention relates to a circular matching system and a circular matching process, which can create a circle in which a plurality of preexisting pairs, in each of which the members are unsatisfied with each other according to predetermined criteria, are swapped in a circular manner to form new pairs whose members are satisfied with the new partners on the basis of the predetermined standards.

### BACKGROUND ART

Generally, there are various cases in which members (persons or articles) of two different kinds are matched with each other in a circular manner to form pairs. Typical examples include organ transplantation and merchandise barter. Whatever the item, it is most important to optimally match a recipient with a donor.

In daily life, it often happens that some commodities, which were once essential to someone, are not needed any more for various reasons. The articles which have become unnecessary, although ideally traded for needed ones, are for the most part neglected in storage areas in houses. Otherwise, the unnecessary articles are sold at prices lower than their real values in second hand markets, which causes economic loss to the owner.

Usually, a recipient and a donor, constituting a pair, are not satisfactory to each other according to criteria for organ transplantation. For example, when a spouse hopes to donate a kidney to the other spouse who has suffered from kidney trouble, such kidney transplantation is ordinarily difficult to conduct because the couple is not related by blood. In general, the spouses of a married couple are not consanguineous so that their physiological conditions are usually unsuitable for the transplantation of kidneys therebetween. In the case where organ transplantation between spouses of a couple is impossible because of various factors such as blood type, tissue type and etc., it may be possible among a pool of couples, who want to donate and receive organs. For example, organs are circularly swapped between at least two couples.

Usually, available organs are not enough to cover the demand for organ transplantation. In addition, whether organ transplantation is possible or not is conventionally dependent on the judgment of transplantation coordinators. The personal determination as well as the limited number of available organ donors makes it difficult to achieve best matches between organ donors and recipients, which entails a declination in the survival rates of the organ recipients as well as in the efficiency of the organ transplantation.

If the number of couples consisting of an organ donor and a recipient is three or more, exchange between organ donors and recipients can be made, but it is almost impossible to find the best matches according to the analysis of the coordinator. Also, the efficiency and objectivity of the organ transplantation is not secured.

For instance, assuming that 100 pairs of organ donors and recipients are available, if organ transplantation is conducted between only two pairs out of them, the theoretical number of combinations among them is 100×99=9900. If three pairs are operated for organic transplantation, the number of combinations configurable in a circular manner among them amounts to 100×99×98=970200. That is, as the number of pairs available for organ transplantation and the number of pairs participating in circular organ exchange increase, the number of exchange combinations is exponentially and factorially amplified.

A general explanation is given of organ transplantation, below.

Organ transplantation is conducted when a patient suffering from an organ disease or failure cannot be cured without receiving a healthy organ from a donor.

In 1906, the first attempts were carried out at human kidney transplantation. Since the first successful human kidney transplant in 1954, considerable progress has been made in kidney transplantation, resulting in a success in the transplantation of other organs such as the heart and the pancreas. The development of cyclosporine, which is a potent immunosuppressant medication, in 1983 has significantly improved the success rate of organ transplants.

Having become a therapeutic modality to treat patients with terminal disease, organ transplantation is nowadays carried out with almost all human body organs, for example, solid organs such as the kidneys, the liver, the pancreas, the heart, the lungs, etc. and even with tissues such as the cornea, marrow, bone, ligaments, the valves of the heart, etc.

Prior to organ transplantation, account must be taken of various factors such as blood type, tissue type, etc. Although consanguineous or in the relationship of married couples, recipients and donors may not agree with each other in blood type or tissue type in many cases. In addition, organ transplantation, even if the blood and tissue types of a donor correspond to those of a recipient, requires a negative result in a histo-compatibility crossmatching assay therebetween.

As basic tests required for organ transplantation, blood pressure, AIDS, B-type hepatitis, C-type hepatitis, urine, blood type (ABO), RH (negative, positive), liver function (9 items) are examined. Biopsy, such as for HLA-A, HLA-B, HLA-C, HLA-DR is also conducted.

Following the basic tests and biopsy, a histocompatibility test is conducted in which a donor's blood is cross matched with a recipient's. A negative response allows the transplantation to be performed.

HLA factors have great influence on long-term survival rates of organ recipients. Analysis shows that when organ transplantation is conducted between unrelated persons, the survival rate over the long term, such as 10 or 20 years, increases as more HLA factors are matched therebetween. Therefore, the more matched HLA factors there are, the more successful the organ transplantation is.

As such, a variety of tests must be performed in advance of organ transplantation so as to determine whether or not given conditions are suitable therefor. It is highly improbable that a recipient who has difficult transplant conditions can meet a suitable donor.

In addition to being directly related to human life, organ transplantation, as described above, requires a wide variety of conditions for more perfect success.

Therefore, what is most important is to choose an optimal donor for a recipient. But yet, conventional methods based on personal judgment are quite inefficient. Further, when the number of couples participating in organ transplantation increases even a little, the conventional methods are impossible to apply to the exchange of suitable recipient-donor couples, thereby lowering transplant success rates.

### DISCLOSURE OF INVENTION

Technical Problem

Accordingly, the present invention has been made keeping in mind the above problems occurring in the prior art, and an object of the present invention is to provide a circular matching system and a circular matching process, which provide a circle in which a plurality of preexisting pairs, in each of which the members are unsatisfied with each other according to predetermined criteria, are swapped in a circular manner to form new optimal or suitable pairs whose members are satisfied with the new partners on the basis of the predetermined standards.

Technical Solution

In order to accomplish the above object, the present invention provides a circular matching system, comprising: an information repository for storing information about pairs comprising recipients and donors and about pair evaluation factors which are to be evaluated for exchanging partners between at least two pairs in a circular manner; and a circular matching engine for creating at least one circle in which the pairs exchange their partners with one another by comparing information about the recipients and the donors on the basis of the stored pair evaluation factors, recipients and donors, said information repository comprising a circle information repository for storing information about the circle created by the circular matching engine.

According to the circular matching system, a circle can be readily created in which a plurality of preexisting pairs, in each of which the members are unsatisfied with each other in article exchange or organ transplantation, are swapped in a circular manner to form new optimal or suitable pairs in which organ transplantation or article exchange is possible. In the case of organ transplantation, the circular matching system of the present invention is very useful in consideration of the fact that the number of voluntary organ donors, who are not associated with recipients, is actually much smaller than that of recipients. That is, non-voluntary donors who are associated with patients (in most cases, married couples, parents and sons or daughters, relatives, etc.) but not suitable for the patients can be effectively matched in a circular manner with recipients of other pairs in the matching system of the present invention, so that more active transplantation can be achieved, together with improved survival rates of patients. Also, the circular matching system of the present invention is utilized for a barter system so that articles can be effectively exchanged among multilateral members.

The system is characterized in that the information repository comprises: a recipient information repository for storing information about recipients; a donor information repository for storing information about donors; and a pair evaluation factor information repository for storing information about pair evaluation factors which are to be evaluated for exchanging partners between at least two pairs in a circular manner.

Another feature of the matching system is that the information repository comprises a circle evaluation factor information repository for storing circle evaluation factors which are to be evaluated for selecting an optimal circle from the circles created by the circular matching engine, and the matching repository engine comprises: an information searching unit for searching the information of recipients and donors in the information repository; a circle creating unit for creating at least one circle on the basis of the information about recipients, donors and pair evaluation factors, searched by the information searching unit; and a circle selecting unit for selecting at least one optimal circle, on the basis of the circle evaluation factors stored in the circle evaluation factor information repository, from the circles created by the circle creating unit.

In the circular matching system, the circular matching engine further comprises a circle combination creating unit for creating at least one circle combination including the optimal circle selected by the circle selecting unit, and the information repository further comprises a circle combination information repository for storing information about the circle combinations created by the circle combination creating unit.

In this circular matching system, the information repository further comprises a circle combination evaluation factor information repository for storing circle combination evaluation factors to be evaluated for selecting at least one optimal circle combination from the circle combinations created by the circle combination creating unit, and the circular matching engine further comprises a circle combination selecting unit for selecting at least one optimal circle combination from the circle combinations created by the circle combination creating unit.

Preferably, the circular matching system further comprises a network connection unit for allowing the information about the circle created by the circular matching engine to be transferred to a client terminal connected to a local host or communication network.

In accordance with the present invention, there is provided a circular matching process realizable on a computer, comprising: (a) storing information about pairs consisting of recipients and donors; (b) storing information about pair evaluation factors to be evaluated for exchanging partners between or among the pairs stored in step (a) in a circular manner; (c) creating at least one circle in which a recipient/donor pair can exchange its partners with another recipient/donor pair, by comparing the information, stored in step (a), about the recipients and the donors on the basis of the stored pair evaluation factors, recipients and the donors; and (d) storing information about all of the circles created in step (c).

Preferably, the circular matching process further comprises: (e) storing information about circle evaluation factors to be evaluated for selecting an optimal circle from among the circles stored in step (d); and (f) selecting at least one optimal circle by evaluating all of the circles stored in step (d) on the basis of circle evaluation factors stored in step (d).

Also preferably, the circular matching process further comprises: (g) storing information about circle combination evaluation factors to be evaluated for selecting an optimal circle combination; (h) creating at least one circle combination consisting of circles which are selected by sequentially conducting a scheme where a next optimal circle is selected from the remaining circles, exclusive of the circles containing the pair participating in the optimal circle selected in step (f); and (i) selecting an optimal circle combination from the circle combinations created in step (h), on the basis of the circle combination evaluation factors stored in step (g).

The circular matching process is characterized in that the information about the circle evaluation factors includes data for preventing the number of pairs constituting a circle from exceeding a predetermined value. Therefore, by preventing the formation of such a large circle as not to exchange members in a circular manner therein, only suitable circles can be created such that the computation is not overloaded on the computer.

In the circular matching process, step (c) comprises: (c1a) selecting all possible donors that are able to form a circular pair with a predetermined recipient; (c1b) creating a pair list containing a list of circular pairs formed by all of the donors selected in step (c1a) and the predetermined recipient; (c1c) judging whether remaining members, who are partners of the members forming the circular pairs of the pair list and have not determined to form a circular pair thus far, can form a circular pair with each other; and (c1d) creating at least one circle if the remaining members are judged to form at least one circular pair in step (c1c); or (c1d′) selecting all possible donors that are able to form a circular pair with the predetermined recipient, from the remaining members and repeating steps (c1b) to (c1d) if the remaining members are judged not to form a circular pair in step (c1c).

In the circular matching process, step (c) comprises: (c2a) dividing the pairs into subgroups; (c2b) creating at least one circle within each of the subgroups divided in step (c2a); and (c2c) repeatedly conducting a scheme comprising forming a lower rank subgroup from the remaining pairs, which are not participants in the creation of the circle in each of the higher rank subgroups and creating a circle within the lower rank subgroup.

In the circular matching process, step (d), if a plurality of donors forms circular pairs with the predetermined recipient, comprises creating a circle with regard to all of the circular pairs containing the recipient and the donors.

Preferably, the circular matching process further comprises: (j) transferring the information about circles, stored in step (d), to a client terminal connected to a local host or a communication network.

In accordance with the present invention, there is provided a circular matching process realizable on a computer, in which a plurality of pairs, members of each pair comprising a recipient and a donor, is evaluated to exchange the members between or among the pairs, and at least one circle which allows the members to be exchanged in a circular manner is created. At this time, if two or more circles are created, they are evaluated to select at least one circle having a higher evaluation value.

In accordance with the present invention, there is provided a circular matching process realizable on a computer, wherein, in a group consisting of at least one unpaired donor and a plurality of pairs, each consisting of a recipient and a donor, the recipients of the pairs are judged to match with the donors, and an open circle is created in which the recipients and the donors are exchanged with one another in a circular manner.

In accordance with the present invention, there is provided a recording medium readable on a computer, having a program for realizing the circular matching process described above on a computer.

Advantageous Effects

According to the circular matching system and the circular matching process of the present invention, a circle can be easily created in which two or more pairs can swap their members to form optimally or suitably matched pairs whose members are satisfied with each other according to predetermined standards. Therefore, the present invention can be applied to an organ transplantation program so that recipients can be effectively matched with optimal donors.

Thus, the present invention contributes to an improvement in the survival rate of recipients.

In addition, the circular matching system and process can be applied to a barter system so that unnecessary articles can be exchanged with needed ones under optimal conditions, thereby producing economic profits.

### BRIEF DESCRIPTION OF THE DRAWINGS

FIG. 1 is a structural diagram showing a circular matching system in accordance with an embodiment of the present invention;

FIG. 2 is a block diagram showing the evaluation of a circle;

FIGS. 3 and 4 are flow charts showing a circular matching process in accordance with an embodiment of the present invention;

FIG. 5 is a conceptual view showing a circle created for organ transplantation in accordance with an embodiment of the present invention;

FIG. 6 is a block diagram schematically showing the circle created in FIG. 5;

FIG. 7 is a table showing circles created on the basis of recipients in accordance with an embodiment of the present invention;

FIG. 8 is a table showing a circle combination consisting of circles created in accordance with an embodiment of the present invention;

FIG. 9 is block diagrams showing circles according to another embodiment of the present invention; and

FIG. 10 is a block diagram showing an open circle according to another embodiment of the present invention.

### BEST MODE FOR CARRYING OUT THE INVENTION

The following embodiment is concerned with pair matching in organ transplantation. As used herein, the term “recipient” means a person who receives an organ(s), the term “donor” is a person who donates an organ(s), and the term “pair” means a couple consisting of a donor and a recipient [(R1, D1)/(R2, D2)/(R3, D3)/ . . . /(Ri, Di)], the term “circular pair” is a pair in which a recipient and a donor, previously unknown to each other, are newly matched due to optimal transplant compatibility to each other, and the term “circle” is a matrix in which two or more pairs exchange their members with each other.

Reference should now be made to the drawings, in which the same reference numerals are used throughout the different drawings to designate the same or similar components.

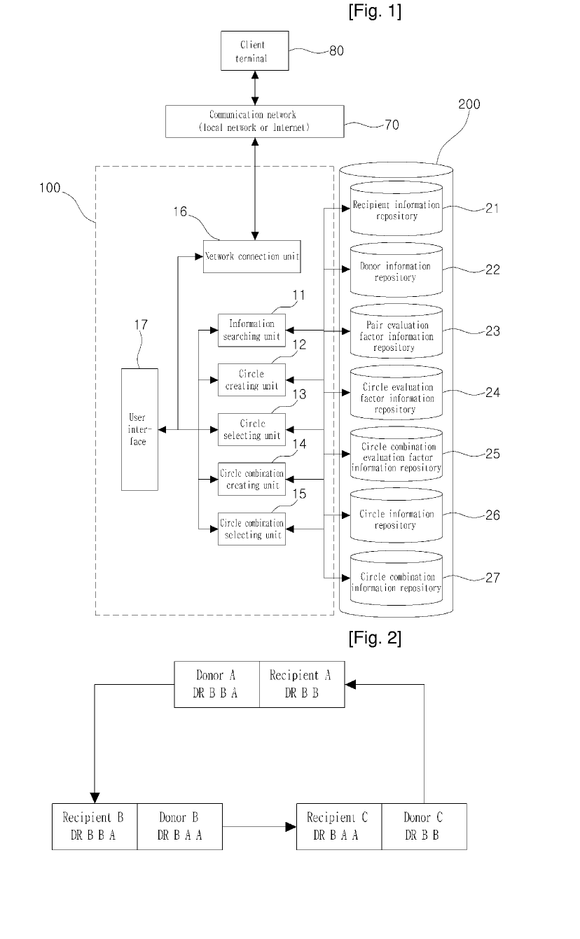

FIG. 1 depicts a detailed structure of a circular matching system according to an embodiment of the present invention.

As seen in FIG. 1, the circular matching system according to an embodiment of the present invention comprises an information repository 200 including a recipient information repository 21, a donor information repository 22, a pair evaluation factor information repository 23, a circle evaluation factor information repository 24, a circle combination evaluation factor information repository 25, a circle information repository 26 and a circle combination information repository 27, and a circular matching engine 100.

In the recipient information repository 21 and the donor information repository 22, information about recipients Ri (i=1, 2, 3, . . . , n) and donors Di (i=1, 2, 3, . . . , n), who participate in an organ transplantation program, is stored. In detail, data representing pairs consisting of two different kinds of members, and information about factors which determine whether or not organ implantation is possible between pairs of recipients and donors, are stored.

In the pair evaluation factor information repository 23 is stored information about factors to be evaluated for organ implantation, that is, factors which are evaluated to determine whether or not organ implantation is possible between a recipient or a donor when they are matched in a circle (hereinafter, referred to as “pair evaluation factors”).

The pair evaluation factors are divided into mandatory evaluation factors for pairs (Pmand) which must be satisfied for organ implantation, and optional quantitative evaluation factors for pairs (Peval), ideally satisfied, which can be quantified.

Examples of the mandatory evaluation factors for pairs (Pmand) include re-quirements that the blood type (ABO, RH) of a donor should be suitable for blood transfusion into a recipient, that cross match tests between a donor and a recipient be negative, that a donor should not be a hepatitis carrier if a recipient does not suffer from hepatitis, etc.

Examples of the optional quantitative evaluation factors for pairs (Peval) include the number of the histocompatibility (HLA) proteins coincident between a donor and a recipient. Herein, an optional quantitative evaluation factor for pairs (Peval) may include a condition in which among the total six combinations of HLA factor DR, A and B, at least one must be matched with the recipient and the donor.

In addition, Peval may be given standards individualized according to pair. For instance, if a patient urgently needing an organ exists, the matched numbers of the HLA factors, considered as Peval, which must be satisfied for a pair including the urgent patient, may be set to be low.

In the circle evaluation factor information repository 24, standard data for evaluating circle creation or assessing at least one circle created (hereinafter, referred to as “circle evaluation factor”) are stored. Like the pair evaluation factors, the circle evaluation factor is divided into a mandatory evaluation factor for circles (Cmand), which must be satisfied, and an optional quantitative evaluation factor for circles (Ceval), which is preferred if satisfied and can be quantified.

Cmand includes a requirement that the pairs constituting a circle be restricted to a predetermined number or below. Because the number of the pairs constituting a circle means the size of the circle, a description is given below using the term “circle size.” Indicating too many pairs participating in a circle, too large a circle size makes circular organ transplantation impossible. This is why the circle size should be limited. In a circle consisting of as many as 100 pairs, for example, it is actually impossible to exchange organs in a circular manner. Accordingly, a circle which does not satisfy Cmand is not created.

Ceval includes the evaluation of a given circle by a size and an average value with a standard deviation. The average value and standard deviation of a circle can be obtained by assessing a plurality of pairs participating in the circle on the basis of Peval. Thus, a higher average value with a narrower standard deviation is preferable, along with a smaller circle size. An example is explained with reference to the circle of FIG. 2. As seen, persons A, B and C participate as both donor and recipient to one another in a circle in such a way that pairs comprising donor A and recipient B, donor B and recipient C, and donor C and recipient A are arranged. Assume that, in this combination, coincident HLA factors are found to be DR, B, B and A between donor A and recipient B, DR, B, A and A between donor B and recipient C, and DR, B and B between donor C and recipient A. HLA factors which improve graft survival are DR>B>A in order. Thus, the HLA factors can be graded by appraisal score, according to the graft survival improvement. For instance, 4 points may be allocated to the coincidence of DR, 3 points to the coincidence of B and 2 points to the coincidence of A. If the circle is evaluated with the design set above, 12 points are given to the pair of donor A and recipient B, 11 points to the pair of donor B and recipient C, and 10 points to the pair of donor C and recipient A. In this way, all circles that are created by participants can be evaluated according to the evaluation points and therefore, average values thereof can be obtained together with their standard deviations. As in the example, Ceval involves a circle size, that is, the number of pairs participating in the circle, and the determination of the average value and standard deviation of the circle by evaluating pairs participating in the circle on the basis of Peval. That is, Ceval is a criterion for determining which is optimal between or among the circles that can be created while satisfying Ptnand and Cmand.

In the circle combination evaluation factor information repository 25 are stored standard data for evaluating at least one circle combination created (hereinafter, referred to as ‘circle combination evaluation factor’). With the aim of determining which is the most preferable among the circles created, the circle combination evaluation factor is divided into standard data which must be satisfied (Smand: mandatory evaluation factors for circles combinations) and standard data, which are preferably satisfied and can be quantified (Seval: quantitative evaluation factors for circles combinations). Smand may be an average value of a given circle combination while Seval may be a standard deviation of a given circle combination. The narrower the standard deviation is, the better it is. The average value of a given circle combination may be obtained by evaluating each of the circles constituting the circle combination on the basis of Peval to afford average values of respective circles, summing up the average values and dividing the obtained total value by the number of circles. More preferable is, as conferred above, the circle combination evaluation factor which has the higher average value among the circle combination with a lower standard deviation.

Information about created circles is stored in the circle information repository 26.

The circle combination information repository stores information about a created circle combination.

When the partners (recipient and donor) of a pair are satisfied with each other or need to meet more suitable partners to satisfy many conditions, the circular matching engine 100 functions to create circles in which at least two pairs can exchange their partners in a circular manner and select an optimal circle out of the created circles. In addition, the engine creates at least one circle combination including the optimal circle and selects an optimal circle combination.

In order to properly perform the function, the circular matching engine 100 comprises an information searching unit 11, a circle creating unit 12, a circle selecting unit 13, a circle combination creating unit 14, a circle combination selecting unit 15, a network connecting unit 16, and a user interface 17.

The information searching unit 11 functions to search the information of recipients and donors in the recipient information repository 21 and the donor information repository 22, respectively.

Using the information of recipients and donors searched by the information searching unit 11, the circle creating unit 12 evaluates the recipients and donors according to Pmand and Cmand to form all possible circular pairs in which transplantation is possible between the members, determines whether the remaining members, who are partners of the members forming the circular pairs and have not determined to form a circular pair thus far, can form a circular pair(s) with each other and creates at least one circle if the remaining members are judged to form at least one circular pair.

The circle selecting unit 13 evaluates the circles created by the circle creating unit 12, on the basis of Ceval, and selects an optimal one from the circles.

Based on Smand, the circle combination creating unit 14 creates at least one circle combination involving at least one optimal circle selected in the circle selecting unit 13.

From a plurality of the circle combinations created in the circle combination creating unit 14, the circle combination selecting unit 15 selects an optimal circle combination through evaluation based on Seval.

Communicating with a client terminal 80 connected to a communication network (local host or the Internet) 70, the network connecting unit 16 allows the obtained circles or circle combinations to be transferred to the client terminal 80 through the user interface 80.

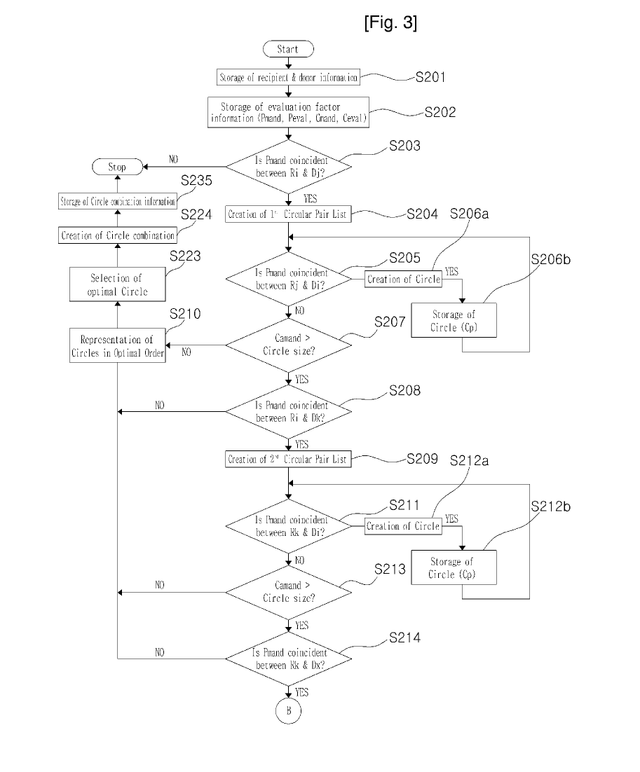

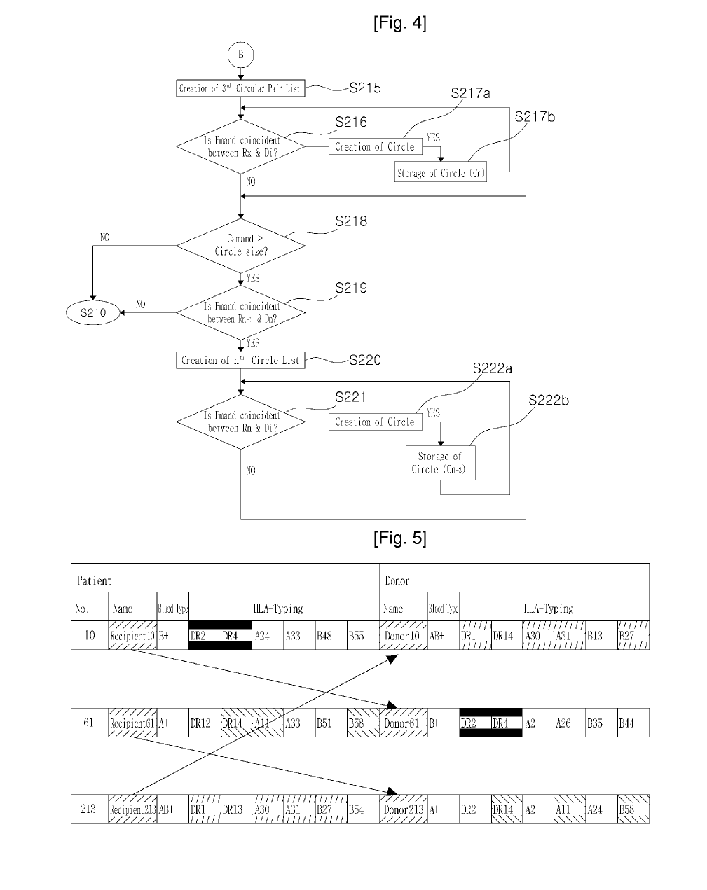

With reference to FIGS. 3 and 4, a circular matching process according to the circular matching system of the present invention is explained, below.

First, information about pairs is stored in the recipient information repository 21 and the donor information repository 22 (S201). The information about pairs includes the conditions of the recipients and donors, that is, the information to be evaluated according to the mandatory pair evaluation factor (Pmand), the information to be evaluated according to the quantitative evaluation factor (Peval), and the information allowing recipients and donors to be identified.

Next, information about pair evaluation factors, circle evaluation factors, and circle combination evaluation factors is stored in the pair evaluation factor information repository 23, the circle evaluation factor information repository 24, and the circle combination evaluation factor information repository 25, respectively (S202).

Evaluation factors, as described above, include pair evaluation factors (mandatory evaluation factors and quantitative evaluation factors), circle evaluation factors (mandatory evaluation factors and quantitative evaluation factors), and circle combination evaluation factors (mandatory evaluation factors and quantitative evaluation factors).

Steps S201 and S202 may be, if necessary, exchanged in order.

For example, where a program is first installed in the circular matching system, information about the evaluation factors may be installed and stored together. In this case, information about evaluation factors may be stored in advance of the storage of the information of recipients and donors.

In addition, the information about evaluation factors may be upgraded by users. For example, in the case where a new mandatory evaluation factor that is necessary for organ transplantation is reported in the medical academic world, the new mandatory evaluation factor may be additionally stored. In this case, the information about evaluation factors is stored after the storage of the information of recipients and donors.

Depending on operation, a step of setting information about evaluation factors may be preferably added in order to perform an evaluation process only on the basis of modified evaluation factors according to a user requirement. For example, assume that a circle size, which is one of the mandatory circle evaluation factors, is restricted to 4, that is, assume that the number of the pairs participating in the circle is 4. When a patient with urgent need exists, if a circle is not formed with 4 pairs, a new condition is preferably set in which the number of participant pairs is restricted to 5.

Based on the information set above, the circular matching engine 100 creates circles with respect to all recipients Ri(i=1, 2, 3, . . . , n) stored in the recipient information repository 21.

In more detail, the circular matching engine 100 selects any recipient Ri and then judges the coincidence of Pmand between the recipient Ri and all donors Dj(j≠i) that can pair with the recipient Ri (S203). That is, the circular matching engine 100 determines whether there is a donor who is able to form a circular pair with the recipient.

If there is a donor able to form circular pairs with the given recipient Ri as judged in Step S203, a primary list that contains the circular pairs consisting of the given recipient Ri and the donors whose Pmand is coincident with that of the recipient Ri (Ri-Dj, . . . , Ri-D1) is created (S204). Of course, if none of the donor agree with the recipient in Pmand, the creation of a circle with respect to the recipient Ri is stopped.

Whether or not the remaining members, who have not been determined to form a circular pair thus far in the primary list of Step S204 and are partners of the members forming the circular pairs of the primary list, can form circular pairs (e.g., Rj-Di, . . . , R1-Di), that is, whether or not Pmand is coincident between the remaining members is determined with respect to each pair (S205). If the remaining members can form a circular pair, a circle is created with respect to each original pair (S206a) and then registered in the circle information repository 26 (S206b). For example, when organ transplantation is judged to be possible between a recipient Ri and a donor Dj and between a recipient Rj and a donor Di, a circle consisting of the two pairs {(Ri-Di)-(Rj-Dj)} is created and registered in the circle information repository 26.

If the remaining members are judged not to form circular pairs in Step S205, it is determined whether the sizes of the circles formed thus far are not more than a preset value (S207). That is, if the number of pairs participating in a circle is set to be 5 or less, whether the number of the pairs which have been, thus far, employed to form a circle is not more than 5 is determined. For example, in the case that an organ is transplanted into a recipient Ri from a donor D1 but cannot be transplanted into a recipient RI from a donor Di, the number of pairs which have been employed, thus far, to form a circle is two {(Ri-Di)-(R1-D1)}, which satisfies Cmand. In further explanation, when the participating pairs, even though satisfying Cmand, cannot form a circle, another pair can be added to form a circle. In contrast, when the participating pairs neither satisfy Cmand nor form a complete circle, the incomplete circle constructed thus far should be discarded.

When a circle is judged to have a size less than a preset value in Step S207, whether or not there is a donor able to form a circular pair with a recipient among the remaining members, who have not participated thus far, is determined by judging the coincidence of Pmand between the recipient and the donor (S208). For example, in the case that organic transplantation is possible between a recipient Ri and a donor D1 but impossible between a recipient R1 and a donor Di, the recipient Ri and the donor D1 form a circular pair. On the basis of Pmand, comparison is conducted to determine whether there is a donor able to form a circular pair with unpaired recipients among the remaining members, who have not been determined to form a circular pair thus far and are partners of the members forming the circular pair, that is, the recipient R1 of the remaining members R1 and Di.

Thereafter, a secondary circular pair list is provided in which a circular pair consisting of the recipient R1 and a donor Dk having coincidence in Pmand therebetween is contained (S209).

For reference, if the preset value, which is Cmand, is judged to be smaller than the size of the circle finally created, in Step S207, the circles created thus far are arranged in optimum order (S210).

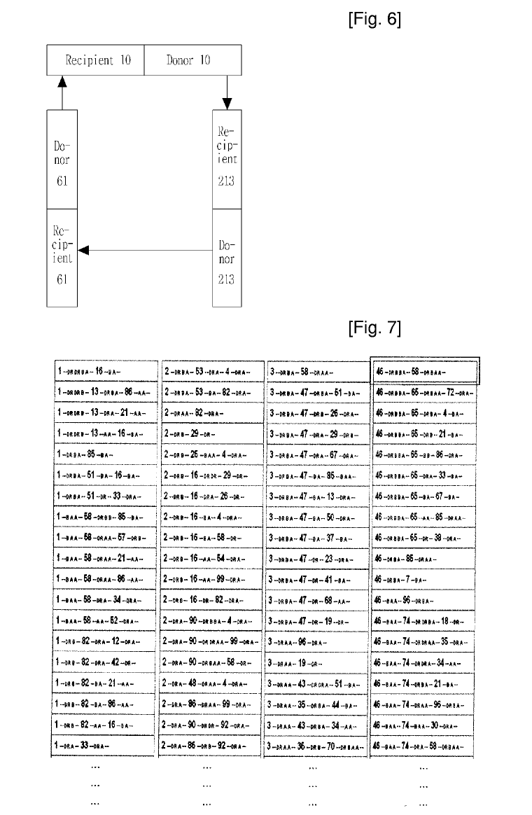

A judgment is made on whether another two members, who are not participants of the circular pairs made thus far but are partners of the participants, are able to form a circular pair (S211). If possible, a circle is created (S212a) and registered in the circle information repository 50 (S212b). For example, the remaining members Rk-Di, not included in the circular pairs (ri-D1)-(R1-Dk) made thus far, are judged to form a circular pair on the basis of Pmand (S211). If the formation is possible, a circle Cq consisting of (Ri, Di)-(R1, D1)-(Rk,Dk) is structured and registered in the circle information repository 50. FIG. 5 shows an example of the circle consisting of three pairs. As shown in FIG. 5, a recipient 10 is ready for receiving a transplant from a donor 61 while organ transplantation is possible from a donor 213 to a recipient 61 and from a donor 10 to a recipient 213. This is schematically illustrated as a loop in FIG. 6.

When the judgment of Step S211, where the recipient Rk and the donor Di are judged to be coincident in Pmand, decides that the recipient Rk and the donor Di cannot form a circular pair, judgment is made on whether the preset value, which is Cmand, is larger than the size of the circle created thus far (S213).

If the preset value is larger than the size, it is determined whether there is any other donor Dx that has the same Pmand as that of the recipient Rk so as to form a circular pair (S214). If a suitable donor Dx is found, a tertiary circular pair list containing the Dx pair {(Ri-D1)-(R1-Dk)-(Rk-Dx), . . . } is created (S215).

On the other hand, if the judgment of Step S213 decides that the Cmand is smaller than the size of the circle, Step S210 is performed, in which the circles created thus far are arranged in optimum order. In order to represent the circles in optimum order, account must be taken of a process for evaluating all of the circles created on the basis of a given recipient Ri by Ceval.

With reference to FIG. 7, there is an example in which all of the circles created with regard to a given recipient Ri (i=1, 2, 3, . . . , n) using the above-described processes are arranged in optimum order. The uppermost circle is the most optimal one among the loops containing the recipient Ri.

As described above, a smallest circular pair list is first created with respect to a given recipient Ri and the circular pair loop thus obtained is registered in the circle information repository 26, after which the circular list is gradually expanded for other recipients inclusive of the recipient Ri. These processes are repeated n times so as to create circular pair lists of 1st- to nth-order and all of the circles thus obtained are registered in the circle information repository 26 (S216-S222b).

The circle selecting unit 26 evaluates all of the circles created thus far, by Ceval, conducts Step S210 to arrange the circles in optimum order, and compares the circles based on the given recipient Ri(i=1, 2, 3, . . . , n) with one another to select the most optimal circle (S223).

In this regard, the selection of the most optimal circle is achieved according to the scores obtained through the evaluation of the circles by Ceval. In FIG. 7, for instance, a circle consisting of 46-58 is selected because it has an evaluation score higher than that of a circle consisting of 1-16, 2-53-4, or 3-58. As described above, the evaluation of the circles is dependent on the average values and standard deviations obtained through the evaluation by Peval as well as on the sizes of the circles.

Afterwards, the circle combination creating unit 14 creates circles with regard to the remaining recipients and donors, who are not contained in the selected circle (4-58), and selects optimal ones from the created circles. This process is repeated to sequentially afford the next best circles which are then combined to form a circle combination only when it satisfies Smand (S224).

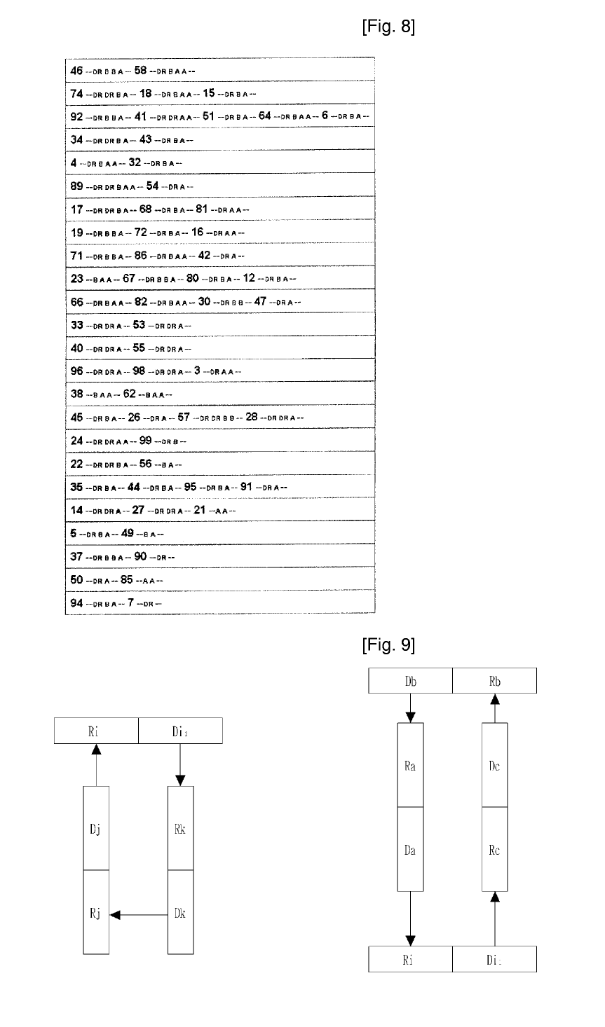

By storing the information, created in Step S224, about the circle combination in the circle combination information repository 27, the circular matching process according to an embodiment of the present invention is completed. FIG. 8 shows an example of the circle combination created in the above-described way.

To combine the circles may result in a plurality of circle combinations. For example, when the evaluation score of the circle 46-58 is identical to that of the circle 3-58 in FIG. 7, a circle combination including the circle 46-58 and a circle combination including the circle 3-58 may be created. Also, if there is a circle that has the same evaluation score as does the next best circle 74-18-15 after the circle 46-58 as seen in FIG. 8, a plurality of circle combinations, each inclusive of the circle 46-58, may be created.

If a plurality of circle combinations is created, the circle combination selecting unit 15 selects the most optimal combination from among them by Seval.

Each of the circles constituting a circle combination is evaluated according to Peval to calculate its average value, followed by calculating an average value of the circle combination. Comparison of the average values of the circle combinations of interest with one another may lead to the selection of a circle combination which has a high average value and a low standard deviation.

According to embodiments, the selection of the most optimal circular ring combination can be accomplished by comparing circles, which have the same optimum order in respective circular ring combinations, with one another and conducting the comparison with regard to all circles in optimum order. In this case, the quantitative evaluation factors for circles combinations (Seval) should be set to be suitable for this purpose.

The circular matching process according to the present invention is completed by the selection of the most optimal circle combination.

For reference, the circular matching method according to the embodiment of the present invention may further comprise sending the created circle combinations to a client terminal (not shown) through a network.

Although the above description is made using pairs, each consisting of one recipient and one donor, the present invention is also true of the case where, for example, a recipient Ri matches two donors Di1 and Di2. In this case, as shown in FIG. 9, all circles are created with respect to (Ri,-Di1) and (Ri,-Di2). Accordingly, the present invention is understood to have more comprehensive applicability. Also, although the above embodiment is recipient-oriented, it is understood that the present invention is readily applicable to donor-oriented matching.

In addition to the embodiments described above, the creation of circles can be modified in various embodiments. For example, a plurality of pairs stored in the recipient information repository and the donor information repository is divided into at least two subgroups, within each of which a circle is created. Using the remaining pairs, which cannot participate in the creation of the circle in each subgroup, a hypo-subgroup is formed. In this hypo-subgroup, a circle is created. In this way, circles can be further created step by step. Processes of selecting an optimal circle, creating circle combinations and selecting an optimal circle combination are also true of these modifications.

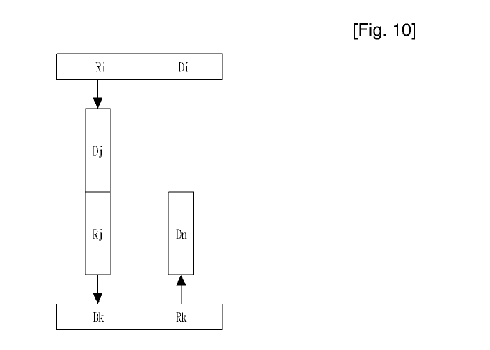

Furthermore, there may be a donor who is alone from the beginning. For example, when a donor participates alone in an organ donation program for which information about three pairs is stored in the recipient information repository and the donor information repository, it is preferable that a circle be created from a pool including the donor. To this case, the method described above can also be applied. For example, while information about (Ri, Di), (Rj, Dj), and (Rk, Dk) is stored, a new donor Dn alone is added. In this case, even though no circle is created among (Ri, Di), (Rj, Dj), (Rk, Dk), the addition of the new donor Dn may make it possible to create a circle. In a more detailed example, where transplantation is possible between Ri and Dj and between Rj and Dk, but impossible between Rk and Di, if an organ can be transplanted from Dn to Rk, an open circle consisting of (Ri-Dj)-(Rj-Dk)-(Rk-Dn) can be created, as seen in FIG. 10.

On the other hand, in the case that there already exists a circle among (Ri, Di)-(Rj, Dj)-(Rk, Dk), the addition of a new donor Dn may lead to an open circle which is higher in average Peval value and lower in standard deviation than the existing circle.

Although explained using organ transplantation, the present invention can be applie d to a barter system.

Assuming that a person wants to trade a clock for an electric mat, a circle can be formed when another person wants to receive a clock for an electric mat. This example can be expanded to a case involving three persons. For the application of the present invention to a barter system, a person and an article may be set as a recipient and a donor, respectively. Also, the mandatory pair evaluation factors may include requirements that a person participating in the barter system be a member, that an article to be bartered be usable, etc. As quantitative pair evaluation factors, purchase price, purchase time, damage degree, etc. are exemplified. The mandatory evaluation factors for the circles may include electronic payment, online payment, courier delivery service, etc. As the quantitative evaluation factor for the circles, more points may be granted to members having higher credit scores and to circles having smaller sizes, etc. As for the circle combination evaluation factor, its mandatory factors may be replaced by an average value of circle combinations and its quantitative evaluation factor may include a standard deviation.

Also, the present invention is concerned with a program for realizing the above-described circular matching system and process on a computer and with a medium on which the program is recorded.

### INDUSTRIAL APPLICABILITY

As described hereinbefore, the present invention provides a circular matching system and a circular matching process that is applicable to organ transplantation as well as a barter trade system, with high efficiency. The present invention contributes to an improvement in the survival rate of recipients, in addition to being applied to a barter system so that unnecessary articles can be exchanged with needed ones under optimal conditions, thereby producing economic profits.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A circular matching system, comprising:
an information repository for storing information about pairs comprising recipients and donors and about pair evaluation factors which are to be evaluated for exchanging partners between at least two pairs in a circular manner; and
a circular matching engine for creating at least one circle in which the pairs exchange their partners with one another by comparing information about the recipients and the donors on the basis of the stored pair evaluation factors, recipients and donors, said information repository comprising a circle information repository for storing information about the circle created by the circular matching engine.

2. The circular matching system as set forth in claim 1, wherein the information repository comprises:
a recipient information repository for storing information about recipients;
a donor information repository for storing information about donors; and
a pair evaluation factor information repository for storing information about pair evaluation factors which are to be evaluated for exchanging partners between at least two pairs in a circular manner.

3. The matching system as set forth in claim 1, wherein the information repository comprises a circle evaluation factor information repository for storing circle evaluation factors which are to be evaluated for selecting an optimal circle from the circles created by the circular matching engine, and the matching repository engine comprises:
an information searching unit for searching the information of recipients and donors in the information repository;
a circle creating unit for creating at least one circle on the basis of the information about recipients, donors and pair evaluation factors, searched by the information searching unit; and
a circle selecting unit for selecting at least one optimal circle, on the basis of the circle evaluation factors stored in the circle evaluation factor information repository, from the circles created by the circle creating unit.

4. The circular matching system as set forth in claim 3, wherein the circular matching engine further comprises a circle combination creating unit for creating at least one circle combination including the optimal circle selected by the circle selecting unit, and the information repository further comprises a circle combination information repository for storing information about the circle combinations created by the circle combination creating unit.

5. The circular matching system as set forth in claim 4, wherein the information repository further comprises a circle combination evaluation factor information repository for storing circle combination evaluation factors to be evaluated for selecting at least one optimal circle combination from the circle combinations created by the circle combination creating unit, and the circular matching engine further comprises a circle combination selecting unit for selecting at least one optimal circle combination from the circle combinations created by the circle combination creating unit.

6. The circular matching system as set forth in claim 1, further comprising a network connection unit for allowing the information about the circle created by the circular matching engine to be transferred to a client terminal connected to a local host or communication network.

7. A circular matching process realizable on a computer, comprising:
(a) storing information about pairs consisting of recipients and donors;
(b) storing information about pair evaluation factors to be evaluated for exchanging partners between or among the pairs stored in step (a) in a circular manner;
(c) creating at least one circle in which a recipient/donor pair can exchange its partners with another recipient/donor pair, by comparing the information, stored in step (a), about the recipients and the donors on the basis of the stored pair evaluation factors, recipients and the donors; and
(d) storing information about all of the circles created in step (c).

8. The circular matching process as set forth in claim 7, further comprising:
(e) storing information about circle evaluation factors to be evaluated for selecting an optimal circle from among the circles stored in step (d); and
(f) selecting at least one optimal circle by evaluating all of the circles stored in step (d) on the basis of circle evaluation factors stored in step (d).

9. The circular matching process as set forth in claim 8, further comprising:
(g) storing information about circle combination evaluation factors to be evaluated for selecting an optimal circle combination;
(h) creating at least one circle combination consisting of circles which are selected by sequentially conducting a scheme where a next optimal circle is selected from the remaining circles, exclusive of the circles containing the pair participating in the optimal circle selected in step (f); and
(i) selecting an optimal circle combination from the circle combinations created in step (h), on the basis of the circle combination evaluation factors stored in step (g).

10. The circular matching process as set forth in claim 8, wherein the information about the circle evaluation factors includes data for preventing the number of pairs constituting a circle from exceeding a predetermined value.

11. The circular matching process as set forth in claim 7, wherein step (c) comprises:
(c1a) selecting all possible donors that are able to form a circular pair with a pre-determined recipient;
(c1b) creating a pair list containing a list of circular pairs formed by all of the donors selected in step (c1a) and the predetermined recipient;
(c1c) judging whether remaining members, who are partners of the members forming the circular pairs of the pair list and have not determined to form a circular pair thus far, can form a circular pair with each other; and
(c1d) creating at least one circle if the remaining members are judged to form at least one circular pair in step (c1c); or
(c1d′) selecting all possible donors that are able to form a circular pair with the predetermined recipient, from the remaining members and repeating steps (c1b) to (c1d) if the remaining members are judged not to form a circular pair in step (c1c).

12. The circular matching process as set forth in claim 7, wherein step (c) comprises:
(c2a) dividing the pairs into subgroups;
(c2b) creating at least one circle within each of the subgroups divided in step (c2a); and
(c2c) repeatedly conducting a scheme comprising forming a lower rank subgroup from the remaining pairs, which are not participants in the creation of the circle in each of the higher rank subgroups and creating a circle within the lower rank subgroup.

13. The circular matching process as set forth in claim 7, wherein step (d), if a plurality of donors forms circular pairs with the predetermined recipient, comprises creating a circle with regard to all of the circular pairs containing the recipient and the donors.

14. The circular matching process as set forth in claim 7, further comprising:
(j) transferring the information about circles, stored in step (d), to a client terminal connected to a local host or a communication network.

15. A circular matching process realizable on a computer, in which a plurality of pairs, members of each pair comprising a recipient and a donor, is evaluated to exchange the members between or among the pairs, and at least one circle which allows the members to be exchanged in a circular manner is created.

16. The circular matching process as set forth in claim 15, wherein, if two or more circles are created, they are evaluated to select at least one circle having a higher evaluation value.

17. A circular matching process realizable on a computer, wherein, in a group consisting of at least one unpaired donor and a plurality of pairs, each consisting of a recipient and a donor, the recipients of the pairs are judged to match with the donors, and an open circle is created in which the recipients and the donors are exchanged with one another in a circular manner.

18. A recording medium readable on a computer, having a program for realizing the circular matching process of one of claims 7 to 17 on a computer.
